(19) United States
(12) Patent Application Publication
(10) Pub. No.: US 2023/0312930 A1
(43) Pub. Date: Oct. 5, 2023

(54) ENGINEERED WOOD ADHESIVES AND ENGINEERED WOOD THEREFROM

(71) Applicant: CARGILL, INCORPORATED, Wayzata, MN (US)

(72) Inventors: Kevin ANDERSON, Cedar Rapids, IA (US); David Edward GARLIE, Eau Claire, WI (US); Flave Eugene MARKLAND, JR., Atkins, IA (US); Shuang ZHOU, Marion, IA (US)

(73) Assignee: CARGILL, INCORPORATED, Wayzata, MN (US)

(21) Appl. No.: 17/999,765

(22) PCT Filed: May 28, 2021
(86) PCT No.: PCT/US2021/034899

§ 371 Date: Nov. 23, 2022

Related U.S. Application Data
(60) Provisional application No. 63/031,902, filed on May 29, 2020.

(51) Int. Cl. C09J 189/00; C08L 97/02

(52) U.S. Cl. CPC C08L 97/02; C09J 189/00

(57) ABSTRACT

According to various examples of the present disclosure, an engineered wood precursor mixture includes a plurality of wood substrates and a binder reaction mixture present in a range of from 3 parts to 25 parts per 100 parts of the dry weight of the plurality of wood substrates. The binder composition includes an aqueous portion. The aqueous portion includes a carbohydrate-containing component in a range of from 2 wt% to 85 wt% based on a dry weight of the binder reaction mixture. The carbohydrate-containing component includes glucose, fructose, or a mixture thereof. The combined wt% of glucose, fructose, or mixture thereof in the carbohydrate-containing component is at least 60 wt%. The aqueous portion further includes 0.1 wt% to 10 wt% sodium trimetaphosphate based on a dry weight of the binder reaction mixture.

### CROSS REFERENCE TO RELATED APPLICATIONS

This application claims the benefit of U.S. Provisional Pat. Application No. 63/031,902, filed May 29, 2020, and entitled “ENGINEERED WOOD ADHESIVES AND ENGINEERED WOOD THEREFROM”, which is incorporated by reference herein in its entirety.

### BACKGROUND

The most commonly used wood adhesives are phenol-formaldehyde resins (PF) and urea-formaldehyde resins (UF). There are at least two concerns with PF and UF resins. First, volatile organic compounds (VOC) are generated during the manufacture and use of lignocellulosic-based composites. An increasing concern about the effect of emissive VOC, especially formaldehyde, on human health has prompted a need for more environmentally acceptable adhesives. Second, PF and UF resins are made from petroleum-derived products. The reserves of petroleum are naturally limited. The wood composite industry would greatly benefit from the development of formaldehyde-free adhesives made from renewable natural resources.

### SUMMARY OF THE DISCLOSURE

According to various examples of the present disclosure, an engineered wood precursor mixture includes a plurality of wood substrates and a binder reaction mixture present in a range of from 3 parts to 25 parts per 100 parts of the dry weight of the plurality of wood substrate. The binder composition includes an aqueous portion. The aqueous portion includes a carbohydrate-containing component in a range of from 2 wt% to 85 wt% based on a dry weight of the binder reaction mixture. The carbohydrate-containing component includes glucose, fructose, or a mixture thereof. The combined wt% of glucose, fructose, or mixture thereof in the carbohydrate-containing component is at least 60 wt%. The aqueous portion further includes 0.1 wt% to 10 wt% sodium trimetaphosphate based on a dry weight of the binder reaction mixture. The binder reaction mixture further includes an at least partially non-dissolved polypeptide-containing component selected from soy flour, wheat gluten, or a combination thereof, in a range of from 20 wt% to 85 wt% based on the dry weight of the binder reaction mixture.

According to various examples of the present disclosure, an engineered wood precursor mixture includes a plurality of wood substrates and a binder reaction mixture present in a range of from 3 parts to 25 parts per 100 parts of the dry weight of the plurality of wood substrate. The binder composition includes an aqueous portion. The aqueous portion includes a carbohydrate-containing component in a range of from 2 wt% to 85 wt% based on a dry weight of the binder reaction mixture. The aqueous portion further includes 1 wt% to 33 wt% of a base based on a dry weight of the binder reaction mixture. A pH of the aqueous portion is greater than 10, for example 10.5, 11, 11.5, 12, 12.5, 13, 13.5, or 14. The carbohydrate-containing component includes glucose, fructose, or a mixture thereof. The combined wt% of glucose, fructose, or mixture thereof in the carbohydrate-containing component is at least 60 wt%. The aqueous portion further includes 0.1 wt% to 10 wt% sodium trimetaphosphate based on a dry weight of the binder reaction mixture. The binder reaction mixture further includes an at least partially non-dissolved polypeptide-containing component selected from soy flour, wheat gluten, or a combination thereof, in a range of from 20 wt% to 85 wt% based on the dry weight of the binder reaction mixture.

According to various examples of the present disclosure, an engineered wood includes a reaction product of an engineered wood precursor. The engineered wood precursor mixture includes a plurality of wood substrates and a binder reaction mixture present in a range of from 3 parts to 25 parts per 100 parts of the dry weight of the plurality of wood substrates. The binder composition includes an aqueous portion. The aqueous portion includes a carbohydrate-containing component in a range of from 2 wt% to 85 wt% based on a dry weight of the binder reaction mixture. The carbohydrate-containing component includes glucose, fructose, or a mixture thereof. The combined wt% of glucose, fructose, or mixture thereof in the carbohydrate-containing component is at least 60 wt%. The aqueous portion further includes 0.1 wt% to 10 wt% sodium trimetaphosphate based on a dry weight of the binder reaction mixture. The binder reaction mixture further includes an at least partially non-dissolved polypeptide-containing component selected from soy flour, wheat gluten, or a combination thereof, in a range of from 20 wt% to 85 wt% based on the dry weight of the binder reaction mixture.

According to various examples of the present disclosure, an engineered wood includes a reaction product of an engineered wood precursor. The engineered wood precursor mixture includes a plurality of wood substrates and a binder reaction mixture present in a range of from 3 parts to 25 parts per 100 parts of the dry weight of the plurality of wood substrates. The binder composition includes an aqueous portion. The aqueous portion includes a carbohydrate-containing component in a range of from 2 wt% to 85 wt% based on a dry weight of the binder reaction mixture. The aqueous portion further includes 1 wt% to 33 wt% of a base based on a dry weight of the binder reaction mixture. A pH of the aqueous portion is greater than 10, for example 10.5, 11, 11.5, 12, 12.5, 13, 13.5, or 14. The carbohydrate-containing component includes glucose, fructose, or a mixture thereof. The combined wt% of glucose, fructose, or mixture thereof in the carbohydrate-containing component is at least 60 wt%. The aqueous portion further includes 0.1 wt% to 10 wt% sodium trimetaphosphate based on a dry weight of the binder reaction mixture. The binder reaction mixture further includes an at least partially non-dissolved polypeptide-containing component selected from soy flour, wheat gluten, or a combination thereof, in a range of from 20 wt% to 85 wt% based on the dry weight of the binder reaction mixture.

According to various examples of the present disclosure, a method of making an engineered wood includes (a) mixing a carbohydrate-containing component and sodium trimetaphosphate to produce a first mixture. The method further includes (b) mixing the first mixture produced at (a) with a plurality of wood substrates to obtain a second mixture. The method further includes (c) mixing the second mixture produced at (b) with a polypeptide-containing component to form a third mixture. The method further includes (d) curing the third mixture formed at (c) to form the engineered wood.

According to various examples of the present disclosure, a method of making an engineered wood includes (a) mixing a carbohydrate-containing component and sodium trimetaphosphate, and a base to produce a first mixture. The method further includes (b)mixing the first mixture produced at (a) with a plurality of wood substrates to obtain a second mixture. The method further includes (c) mixing the second mixture produced at (b) with a polypeptide-containing component to form a third mixture. The method further includes (d) curing the third mixture formed at (c) to form the engineered wood. The first mixture produced at (a) is aqueous and the sodium trimetaphosphate is in a range of from 0.1 wt% to 1 wt%, the carbohydrate component is present in a range of 20 wt% to 85 wt%, the base is present in a range of from 1 wt% to 33 wt%, and the polypeptide component is present in a range of from 20 wt% to 85 wt%, each based on a dry weight of the polypeptide-containing component, carbohydrate-component, and the sodium trimetaphosphate.

The aqueous portion of the binder composition has an initial viscosity (prior to curing) at 25° C. of 5 cPs to 1,000 cPs, from 10 cPs to 500 cPs, from 50 cPs to 300 cPs, and where low viscosity is particularly beneficial, from 10 cPs to 100 cPs at 25° C.

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

The term “substantially” as used herein refers to a majority of, or mostly, as in at least 90%, 95%, 99.5%, or 100%. The term “substantially free of” as used herein can mean having none or having a trivial amount of, such that the amount of material present does not affect the material properties of the composition including the material, such that 0 wt% to 5 wt% of the composition is the material, or 0 wt% to 1 wt%, or 5 wt% or less, or 0 wt%.

According to various aspects of the instant disclosure, an engineered wood product is described. The engineered wood product can typically take the form of a particle board, medium density fiber board, high density fiberboard, oriented strand board, engineered wood flooring, and combinations thereof. The engineered wood product can be sized to have any suitable dimensions. For example, the engineered wood product can be sized to be 1.2 meters wide and 2.6 meters long, or 1.3 meters wide and 2.1 meters long. These dimensions are merely meant to be examples and do not limit the sizes of engineered wood products that can be produced.

The engineered wood product can typically include a variety of constituents. For example, the engineered wood product can typically include a plurality of wood substrates bound together by a binder that is a reaction product of a binder reaction mixture including an at least partially non-dissolved polypeptide component distributed about the binder reaction mixture. In the engineered wood product, the binder that is the reaction product of the binder reaction mixture, can typically be present in a range of from 3 parts to 25 parts per one hundred (100) parts of the dry weight of the plurality of wood substrates, for example from 4.5 parts to 23.5 parts, 3 parts to 20 parts, or 8 parts to 17 parts per one hundred parts of the dry weight of the plurality of wood substrates. Having levels of binder in these ranges can contribute to the engineered wood product having favorable or desirable physical properties, while effectively minimizing the amount of binder that is needed to bind the plurality of wood substrates. The binder can be characterized as a biopolymer.

Examples of desirable physical properties of the engineered wood products can include the product’s internal bond strength (IB), modulus of rupture (MOR), Modulus of Elasticity (MOE), and Thickness Swell Percent (Thickness swell%) as measured for example in Working Example 2. The modulus of rupture of the engineered wood product measures the amount of force required to result in rupturing the engineered wood product. The modulus of rupture can be measured, for example, according to ASTM D1037-99. While the modulus of rupture value can depend on a variety of factors, including the engineered wood product’s density, length, width, thickness, or a combination thereof, the modulus of rupture can generally be in a range of from 0.5 N/mm² to 25 N/mm² or from 2 N/mm² to 22 N/mm².

The modulus of elasticity is a quantity that measures engineered wood product’s resistance to being deformed elastically (e.g., non-permanently) when a stress is applied to it. The modulus of elasticity can be measured, for example, according to ASTM D1037-99. While the modulus of elasticity value typically depends on a variety of factors, including the engineered wood product’s density, length, width, thickness, or a combination thereof, the modulus of elasticity can be in a range of from 200 N/mm² to 3000 N/mm² or from 500 N/mm² to 2750 N/mm².

The thickness swell% is a quantity the measures the engineered wood product’s resistivity to water penetration. The higher the value, the greater the amount of water that is penetrated. This can result in the engineered wood product swelling or otherwise deforming. For example, the engineered wood product may expand past a desired amount. This can be undesirable, if the engineered wood product has precise features such as bore holes, flanges, grooves, or the like, that are designed to fit precisely with a corresponding feature on another product. The thickness swell% value can be measured, for example, according to ASTM D1037-99. According to some aspects, the thickness swell% after soaking the engineered wood in water for two hours to twenty-four hours can be as low as zero. However, other acceptable values include those in a range of from 5% to 45% or from 20% to 40%, measured after soaking the engineered wood in water for two hours to twenty-four hours.

The internal bond strength is a quantity that measures the strength of an article to resist rupturing in a direction perpendicular to the surface of the article. The internal bond strength can be measured, for example, by ASTM D1037-99. According to some aspects, the internal bond strength of the engineered wood can be in a range of from 0.1 N/mm² to 0.5 N/mm² or from 0.2 N/mm² to 0.4 N/mm².

A benefit of using the engineered wood products formed using the materials and methods described herein, is that the properties of the engineered wood products typically are generally comparable to those of a corresponding engineered wood product differing in that it uses a urea-formaldehyde (UF) binder. Urea-formaldehyde resin is a synthetic resin produced by the chemical combination of formaldehyde (a gas produced from methane) and urea (a solid crystal produced from ammonia). Urea-formaldehyde resins are used mostly for gluing plywood, particleboard, and other wood products. Urea-formaldehyde resins polymerize into permanently interlinked networks which are influential in the strength of the cured adhesive. After setting and hardening, urea-formaldehyde resins form an insoluble, three-dimensional network and cannot be melted or thermo-formed.

However, there are a number of disadvantages associated with using urea-formaldehyde. For example, addition of water, in high temperature, cured urea-formaldehyde can hydrolyze and release formaldehyde, this weakens the glue bond and can be toxic. Moreover, urea-formaldehyde must be used in a well ventilated area because uncured resin is irritating and can be toxic. Additionally, urea-formaldehyde adhesives generally have a limited shelf life.

The materials described herein can address at least some of these drawbacks and, in particular, prevent the outgassing of substantially any formaldehyde. Moreover, according to various aspects, the modulus of rupture, the thickness swell%, modulus of elasticity, internal bond strength, or a combination thereof of the engineered wood can be substantially similar to a modulus of elasticity, modulus of rupture, a thickness swell%, internal bond strength, or a combination thereof of a corresponding engineered wood differing in that the reaction product comprises urea-formaldehyde, or a mixture thereof. More specifically, the thickness swell%, modulus of elasticity, modulus of rupture internal bond strength, or a combination thereof of the engineered wood can be within 1% to 10%, 1% to 5%, or is substantially identical to the modulus of elasticity, modulus of rupture, the thickness swell%, internal bond strength, or a combination thereof of the corresponding engineered wood. However, in further aspect modulus of elasticity, modulus of rupture, the thickness swell%, internal bond strength, or a combination thereof can be within 50% to 150% of the corresponding engineered wood.

The properties of the engineered wood products described herein can be further achieved or enhanced for example by distributing the binder such that it is substantially homogenously distributed about the plurality of wood substrates. Other properties such as the thickness swell% can typically be achieved or enhanced by adding a swell-retardant agent such that it is distributed about the engineered wood. The swell-retardant agent can include a wax emulsion that can sustain (e.g., remain stable) a high pH environment that is greater than 10. Where present, the swell-retardant can be from 0.1 wt% to 1 wt% or from 0.5 wt% to 0.7 wt% of the engineered wood product.

Although the engineered wood product has been described as a singular object, it is within the scope of this disclosure for the engineered wood product to be a component of a larger structure. For example, the engineered wood product can be part of a laminate structure where the engineered wood product constitutes an inner or outer layer of the laminate structure. The engineered wood product can be in contact with a core structure (e.g., a wood, plastic, or metal core) or another engineered wood product that has a substantially identical construction or a different construction. The core structure can constitute the whole engineered wood product or it can be a component of the engineered wood product.

The engineered wood described herein is formed from an engineered wood precursor mixture. The engineered wood precursor mixture includes a least a plurality of wood substrates, an aqueous portion of a binder reaction mixture and a peptide-containing component distributed about the binder reaction mixture. The plurality of wood substrates can include one or more wood particles, one or more wood substrates, or one or more wood strands. The wood substrates can include a wood material such as pine, hemlock, spruce, aspen, birch, maple, or mixtures thereof.

Relative to the plurality of wood substrates, the binder reaction mixture can typically be present in a range of 3 to 25 parts per one hundred parts of the dry weight of the plurality of wood substrates. In some aspects, the preferred range is from 12 parts to 14 parts per one hundred parts of dry wood substrate. The binder composition can typically include a carbohydrate-containing component, a sodium trimetaphosphate (STMP), and, optionally, a base material. Furthermore, a polypeptide containing component can be distributed about the binder reaction mixture after the carbohydrate, base and wood substrate(s) are mixed. The polypeptide containing component can typically be substantially non-dissolved.

The carbohydrate-containing component can be in an aqueous form in a range of from 2 wt% to 85 wt% based on a dry weight of the binder reaction mixture or from 15 wt% to 65 wt%. In some aspects, the preferred range is from 48 wt% to 50 wt%, based on the dry weight of the binder reaction mixture. The carbohydrate-containing component includes glucose, fructose, or a mixture thereof. In some examples, the carbohydrate-containing component can include sucrose. In the carbohydrate component, the combined wt% of glucose, fructose, or mixture thereof in the carbohydrate component is at least 60 wt%. In some aspects, the carbohydrate component includes a glucose syrup, high fructose corn syrup, or a mixture thereof. In some aspects the carbohydrate component includes a carbohydrate such as a monosaccharide such as glucose, fructose or mixtures thereof and the total weight percent of glucose and fructose is in the range of 20 wt% to 60 wt% based on dry weight of the binder reaction mixture. In some aspects, the carbohydrate component includes a glucose syrup having a dextrose equivalent (DE) of at least 60, at least 80, at least 85, at least 90, or at least 95. As understood herein, dextrose equivalent is a measure of the amount of reducing sugars present in a sugar product, expressed as a percentage on a dry basis relative to dextrose. In some further aspects, the carbohydrate-containing component includes a high fructose corn syrup comprising at least 90 wt% fructose and glucose. In some aspects, the high fructose corn syrup can include at least 94 wt% fructose and glucose. In some aspects, the high fructose corn syrup includes from 30 wt% to 70 wt% glucose or from 35 wt% to 65 wt% glucose.

Typically, the carbohydrate(s) of the carbohydrate-containing component will be a carbohydrate that has at least one reducing group (the reducing group can be a reducing end group in some aspects). It is possible for the carbohydrate component to have a mixture of carbohydrates with a reducing group and carbohydrates without a reducing group too, but in these cases there are likely to be at least some carbohydrates with a reducing group. The reducing group(s) (e.g., aldehyde group(s), ketone group(s), or a mixture thereof) available on the carbohydrates allows for a bond to formed between it and an amine group of the polypeptide component during curing to form a biopolymer or network thereof. It was found that using monosaccharides in the carbohydrate-containing component, in particular, the internal bond strength, thickness swell%, modulus of rupture, and modulus of elasticity of the resulting engineered wood.

The sodium trimetaphosphate can be present in the in the binder reaction mixture in a range of from 0.1 wt% to 10 wt%, or 0.4 wt% to 0.9 wt%, or even 0.6 wt% to 0.8 wt%, based on the dry weight of the binder reaction mixture. In some aspects, the preferred range is from 0.7 wt% to 0.9 wt%, based on the dry weight of the binder reaction mixture. Without being limited to any theory, it is understood that including sodium trimetaphosphate can help to allow for higher levels of carbohydrate to be present in the binder reaction mixture. Additionally, it is believed that including sodium trimetaphosphate can be helpful to increase at least the internal bond strength in an engineered wood produced using the binder reaction mixture. It is also believed that including sodium trimetaphosphate can be helpful to improve the thickness swell% values of the engineered wood using the binder reaction mixture.

When present, the base can typically be present in the binder reaction mixture in a range of from 1 wt% to 33 wt% or 4 wt% to 7 wt% based on a dry weight of the binder reaction mixture. In some aspects, the preferred wt% is 5.0 wt% to 7.0 wt%, based on the dry weight of the binder reaction mixture. The base can typically be added to such a degree that a pH of the aqueous portion of the binder reaction mixture is greater than 10, for example 10.5, 11, 11.5, 12, 12.5, 13, 13.5, or 14. The pH therefore is typically in a range of from 10 to 14 or 11 to 14. Typically, the base includes NaOH, magnesium oxide, or mixtures thereof. In some aspects, the base includes solely NaOH. It was found that using a base to achieve these pH values, in particular, led to improvement in the thickness swell%, modulus of rupture, and modulus of elasticity of the resulting engineered wood.

While not intending to be limited to any theory, it is believed that the base, at the disclosed concentration results in the high pH environment enhances the reaction between the carbohydrate-containing component, polypeptide-containing component, and wood substrate to form a biopolymer network enveloping the wood substrate. For example, it is believed that the base can help to dissolve at least a portion of individual wood substrates. This, in turn, allows the binder precursor solution to penetrate at least partially into the interior of the individual wood substrate. Therefore, when the binder precursor is subjected to curing a greater degree of interlocking between the binder and the individual wood substrates can be achieved. The relatively high pH cannot be used in conjunction with a process that is used to produce select Maillard reaction products, which typically cannot tolerate a pH higher than 10, such as found in U.S. Pat. No. 8,501,838.

The precursor further includes an at least partially non-dissolved polypeptide-containing component distributed about the carbohydrate-containing component and wood substrate. The concentration of polypeptide-containing component is measured based on the dry weight of the binder reaction mixture. The concentration of the polypeptide-containing component can typically be in a range of from 20 wt% to 85 wt%, 30 wt% to 80 wt%, or 40 wt% to 65 wt%. In some aspects the preferred range is 42 wt% to 44 wt%.

The polypeptide-containing component can typically include a protein sourced from an animal protein, a casein salt, a plant protein, a soy flour, linseed flour, flaxseed flour, cottonseed flour, canola flour, sunflower flour, peanut flour, lupin flour, pea flour, and mixtures thereof. In some aspects the polypeptide-containing component includes a protein sourced from soy flour, wheat gluten, or a combination thereof. In some aspects, the polypeptide-containing component includes a protein sourced from soy flour. The soy flour can be from 40 wt% to 65 wt% or 50 wt% to 60 wt%, protein based on the total soy flour present. Where the polypeptide-containing component is a mixture such as a flour, it is possible for it to include non-protein constituents such as a carbohydrate. In these instances, the disclosed concentrations of the carbohydrates in the binder precursor, or reaction product thereof, are independent of the amount of carbohydrate present from the polypeptide-containing component. It has been surprisingly and unexpectedly found that mixtures including soy flour produce engineered wood products having better properties than a corresponding engineered wood formed with constituents having higher percentages of protein.

In certain aspects, where the polypeptide-containing component includes soy flour, the soy flour can have a protein dispersibility index of at least 60. For example, a protein dispersibility index of the soy flour can be in a range of from 70 to 95, for example a PDI from 80 to 90. If it is desired to screen the polypeptide-containing component by size, the component can be selected from one that passes through a screen sized 100-mesh screen to a 635-mesh screen or a 100-mesh screen to a 400-mesh screen, for example a screen size can be from 150 to 325.

In certain aspects, the engineered wood precursor mixture can include sodium sulfite, sodium bisulfite, sodium metabisulfite or a mixture thereof. Where present, the sodium sulfite, sodium bisulfite, or a mixture thereof is in a range of from 1 wt% to 10 wt% or from 1 wt% to 5 wt%, based on the dry weight of the binder reaction mixture. Including sodium sulfite, sodium bisulfite, or a mixture thereof can help to increase the strength of the resulting engineered wood product. For example, they can help to increase the modulus of rupture, modulus of elasticity, or both of the engineered wood, relative to a corresponding engineered wood that is free of sodium sulfite, sodium bisulfite, or a mixture thereof. However, in certain aspects, including sodium sulfite, sodium bisulfite, or a mixture thereof can increase the sulfur content of the engineered wood, which may be detrimental for certain applications.

As described previously, the binder is substantially free of a urea-formaldehyde. Therefore, the precursors described herein are also free of a urea-formaldehyde. For example, the mixture can typically include less than 5 wt% of urea-formaldehyde or be substantially free of urea-formaldehyde.

The moisture content of the mixture of the binder and the plurality of wood substrates can be carefully controlled. For example, the moisture content typically is in a range of from 7% to 25%, 7% to 20%, 8% to 15% or in a range of from 10% to 13%. The moisture content can affect the ability to disperse the components of the mixture about the wood substrates and the reactivity of the substrates. The moisture content can be tuned, for example by increasing or decreasing the moisture content in the binder. For example, if the moisture content in the wood is low, the moisture content in the binder can be increased to bring the total moisture content of the mixture of the binder and plurality of wood substrates to a desired level. In some aspects moisture can be added to the binder by spraying water to the binder distributed on the wood substrates. However in certain aspects, water can simply be added to the carbohydrate-containing component before it is applied to the wood substrate. This can give better distribution of the moisture across the mixture of binder and wood substrates.

The engineered wood described herein can be made or manufactured according many suitable methods. As an example, a method can include (a) mixing the carbohydrate-containing component, sodium trimetaphosphate, and optionally, the base to produce a first mixture.

After the carbohydrate-containing component and base are sufficiently mixed, the method can further include (b) mixing the mixture produced at (a) with the plurality of wood substrates to obtain a second mixture. To help to achieve a uniform blend, mixing at (b) is typically performed by spraying the carbohydrate-containing component and, where present, the base to the plurality of wood substrates. The spraying and mixing can typically occur for a time in a range of from 1 minute to 60 minutes or 1 minute to 10 minutes. It was found that increased mixing times resulted in stronger engineered woods.

After mixing at (b) is performed, the method further includes (c) mixing the mixture produced at (b) with the polypeptide-containing component to form a third mixture. The polypeptide-containing component at this stage can be in a powder form. It has been found that the properties of the resulting engineered wood (e.g., modulus of rupture, modulus of elasticity, thickness swell%, internal bond strength, or a combination thereof) are better when the polypeptide-containing component is in powder form as opposed to a dispersion form.

Before performing step (b), the first mixture obtained at (a) can be used immediately. However, the first mixture obtained at (a) can also be aged for example, for at least 1 hour, or at least 12 hours. And, surprisingly and unexpectedly it has been found that the mixture obtained at (a) can effectively be use when aged for 26 hours or greater before performing (b), for example, the first mixture can be aged for at least 50 hours, at least 120 hours, at least 360 hours, at least 1400 hours, at least 2000 hours, from 26 hours to 1400 hours, or from 50 hours to 360 hours before performing (c). These times can be reduced by heating the mixture. The step at (c) is typically performed for at least 1 minute, for example in a range of from 1 minute to 60 minutes or from 1 minute to 10 minutes.

Before performing step (d), the third mixture formed during step (c) exhibits tack properties comparable or improved relative to alternative binder systems (e.g., those using a urea-formaldehyde binder). Tack is the adhesive property that imparts upon the materials being bound, the ability to lightly stick together with gentle pressure. Tack is typically an important property for maintaining the shape and distribution of wood fibers within the mattress during initial formation throughout the particleboard manufacturing process. Increasing the carbohydrate-containing component portion of the aqueous portion of the binder reaction mixture during step (b) appears to visually improve the tack properties of the resulting binder reaction mixture.

After mixing at step (c) is performed, the method further includes (d) curing the third mixture formed at (c) to form the engineered wood. Curing can include (e) hot pressing the binder reaction mixture formed at (d). Hot pressing at (e) is performed at a pressure of at least 5 psi and at most 500 psi, from 5 psi to 450 psi, or from 30 psi to 400 psi. In addition to the pressure, a platen of the press used for hot pressing at (e) is heated to a temperature in a range of at least 100° C., for example, at least 120° C., at least 130° C., in a range of from 100° C. to 170° C., or in a range of from 120° C. to 160° C. The method can further include a “cold pressing” step that can occur before or after the hot pressing. Cold pressing, if used, can occur at ambient temperatures.

Any of the swell-retardant components described herein can be added to the wood substrate at any point during the method at step (a), (b), (c), or a combination thereof. Similarly, sodium sulfite, sodium bisulfite, sodium metabisulfite or a mixture thereof can be added to the method at step (a), (b), (c), or a combination thereof.

It has been found however, that performing at least steps (a), (b), and (c) in sequential order improves the properties in the engineered wood. Specifically, the modulus of rupture, modulus of elasticity, internal bond strength, and thickness swell% in the resulting engineered wood are improved as compared to corresponding engineered woods formed in a different order. Without intending to be bound to any theory, it is believed that performing these steps in order helps to achieve an even spread of the carbohydrate-containing component on the wood substrate. Moreover, the carbohydrate-containing component is at least partially embedded into the wood substrate by virtue of the base creating openings in the wood substrate. Thus, when the polypeptide-containing component comes into contact with the carbohydrate-containing component, the reaction between the two is uniform. It was found that including the polypeptide-containing component along with the wood substrate, base, and carbohydrate-component in one step reduced the thickness swell%, modulus of rupture, and modulus of elasticity of the resulting engineered wood.

### WORKING EXAMPLES

Various aspects of the present disclosure can be better understood by reference to the following Working Examples which are offered by way of illustration. The present disclosure is not limited to the Working Examples given herein. Unless indicated to the contrary, binder dose values are expressed as Parts Binder Reaction Mixture per 100 parts dry weight wood fibers (WF), which refers to the parts dry binder reaction mixture based on 100 parts dry wood fiber; the wood used in the examples had a moisture content of from six percent by weight (6 wt%) to nine weight percent (9 wt%); and %NaOH, % Prolia 200/90, % carbohydrate-containing component, % monosaccharide, % sodium trimetaphosphate, etc. refer to dry weight percent of the indicated component based on the total dry weight of the binder reaction mixture.

TABLE 1

| | |
|---|---|
| Name | Supplier |
| IsoClear 42% | A high fructose corn syrup, available from Cargill, INC, Wayzata, MN |
| Prolia 200/90 | A soy flour having protein content of 52.5% and a 200 mesh particle size and a polydispersity index (PDI) of 90, available from Cargill, INC, Wayzata, A soy flour, available from Cargill, INC, Wayzata, MN |
| Sodium trimetaphosphate | Sodium trimetaphosphate available from ICL Performance Products, LP, Tel Aviv, IL |
| NaOH | A 50% solution of Sodium Hydroxide, available from Arcos Organics, Fair Lawn, NJ |
| Wood Fiber (WF) | Wood Fibers, available under the trade designation MINI FLAKE, available form America’s Choice, Columbia, MD |

### Working Example 1: Binder Preparation and Preparation of Particle Boards

A pre-weighed amount of water (W_{A}) and 50% alkaline solution such as an NaOH solution are mixed to form a diluted alkaline solution including NaOH, which is allowed to cool down to 25-30° C. A carbohydrate-containing component such as an IsoClear 42% high fructose corn syrup solution is slowly added to the diluted NaOH solution along with sodium trimetaphosphate. After completing the addition of IsoClear 42% high fructose corn syrup, the base, and sodium trimetaphosphate, the aqueous portion of the binder reaction mixture is placed on a shaker for 5 minutes. With respect to the W_{A}, the total water content of the binder and wood fiber (WF) is targeted at 11%. The ratio of the dry binder to dry wood fiber is 13.1:100 (e.g., 13.1 parts per 100 parts of dry WF). The water content to be added to the aqueous portion of the binder reaction mixture is calculated based on the third mixture moisture content, the wood fiber moisture and total binder moisture content

The moisture content of wood fiber and polypeptide are measured by a Mettler Toledo moisture balance at 130° C. W_{A} is determined according to Equation 1:

$${\text{W}}_{\text{A}} = {\text{W}}_{\text{T}} - {\text{W}}_{\text{WF}} - {\text{W}}_{\text{BF}} \qquad \text{(Equation 1)}$$

W_{A}: Water to be added to the aqueous portion of the binder reaction mixture
W_{T}: Total moisture of the third mixture
W_{WF}: Water in wood fiber
W_{BF}: Water in the binder ingredients including water in carbohydrates, NaOH, sodium trimetaphosphate, and polypeptides

The carbohydrate, sodium trimetaphosphate, and alkaline solution above is blended and sprayed to the wood fiber (WF) and mixed for 5 minutes to allow for sufficient dispersion. This is followed by the addition of the polypeptide-containing component in a powder form. The mixture of the wood fiber and the binder was then blended for 2 minutes. This process is repeated as needed.

A 91.4 cm x 91.4 cm Nordberg hot press utilizing a Pressman control system is set at 154° C. to maintain working conditions in a range of from 150-177° C. Typical platen temperatures are 153° C. The combination of the binder (blended carbohydrate, sodium trimetaphosphate, and alkaline solution) and the wood fiber described above is uniformly mixed for 5-10 minutes within a Littleford horizontal continuous mixer, available from B&P Littleford, Saginaw, MI, or equivalent apparatus. The combined wood fiber and binder called a furnish, is then transferred into at forming box which is placed on top of a release paper lined caul plate situated on a portable table. The furnish is then evenly distributed across the bottom of the forming box and caul plate to the desired thickness. A 76.2 cm x 76.2 cm metal collar frame is then placed evenly inside the forming box and on top of the furnish. A metal cover is then placed into the forming box and used to gently push the collar and wood fiber together to create a mat that will be pressed. The forming box is then lifted off the bottom caul plate, leaving the furnish and cover standing alone. The metal cover is carefully removed and a second release paper liner placed on top of the mat, followed by a second caul plate. The entire assembly of the two caul plates with the mat sandwiched between them is then transferred into the hot press. A temperature and pressure probe is inserted into the center of the mat to monitor internal conditions throughout the pressing cycle. The press platens are then slowly closed to a predetermined distance necessary to maintain a particle board thickness of in a range of from 1.85 cm to 2.16 cm with 1.91 cm being the desired measurement. The mat is held for a time in a range of from 190 to 195 seconds and then bottom platen is slowly lowered within 30 seconds to release pressure in the particle board. The caul plates and finished particle board are then transferred back onto the movable table. Removing the top caul plate reveals the particle board which is then placed into a cooling rack. The particle board is removed and allowed to condition at the proper requirements for testing. After conditioning, the particle board is tested for various properties including Modulus of Rupture (MOR), Modulus of Elasticity (MOE), Thickness Swell %, and Internal Bond Strength (IB).

Multi-layer particle boards can be formed by the same process expect that multiple layers are stacked and pressed together. Alternatively, separate particle boards can be formed and one particle board can be cut lengthwise in half. Each half is then placed in contact with either major surface of another particle board to form an assembly, which is pressed to form a final assembly including three layers of particle boards.

### Working Example 2: Determination of Modulus of Rupture (MOR), Modulus of Elasticity (MOE), Thickness Swell %, and Internal Bond Strength (IB)

The modulus of rupture, modulus of elasticity, thickness swell %, and internal bond strength were determined using modified ASTM D 1037-06a. ASTM D 1037-06a was modified in that the test specimens used were conditioned under 50% relative humidity and at 21.1° C. (70° F.). For each of the particle boards designated in Table 3 as comparative particle board, particle board 1, particle board 2, and particle board 3; the modulus of rupture, modulus of elasticity, thickness swell %, and internal bond strength were determined by taking the respective particle boards, each having dimensions of 91.44 cm wide x 91.44 cm long with a thickness of 2.08 cm and ultimately generating one or more test specimens from the particle board. Creating the test specimens included cutting down the particle boards to create a sample particle board. The sample particle board was cut to have dimensions of 76.20 cm wide x 76.20 cm long with a thickness of 2.08 cm. To determine the modulus of rupture, modulus of elasticity, thickness swell %, and internal bond strength, several test specimens were created from the sample particle board. Creating several test specimens is helpful to account for the properties of the particle board at different orientations and locations (including edge effect). To determine the modulus of rupture and modulus of elasticity, 9 test specimens each having dimensions of 50.80 cm long (with a span length of 45.72 cm) x 7.62 cm wide with a thickness of 2.08 cm were created from sample particle boards. The modulus of rupture and modulus of elasticity for each test specimen was collected and those values were averaged to yield the modulus of rupture and modulus of elasticity of the particle board. To determine the internal bond strength, 21 test specimens each having dimensions of 5.08 cm long x 5.08 cm wide with a thickness of 2.08 cm were created from sample particle boards. The internal bond strength for each test specimen was collected and those values were averaged to yield the internal bond strength of the particle board. To determine the thickness swell %, 3 test specimens each having dimensions of 15.24 cm long x 15.24 cm wide with a thickness of 2.08 cm were created from particle wood boards. The internal bond strength for each test specimen was collected and those values were averaged to yield the thickness swell % of the particle board.

### Working Example 3: Binder Formulations

Three binder formulations were prepared and included the constituents listed in Table 1. All wt% values are relative to the dry weight of the binder formulations constituents.

TABLE 2

| Constituent | Comparative Binder | Binder 1 | Binder 2 |
|---|---|---|---|
| Prolia 200/90 | 55.0% | 54.6% | 43.7% |
| IsoClear 42% | 38.8% | 38.7% | 49.6% |
| NaOH | 6.2% | 6.0% | 6.0% |
| Sodium Trimetaphosphate | - | 0.8% | 0.8% |

### Working Example 4: Particle Properties

Various particle boards (particle comparative particle board, particle board 1, particle board 2, and particle board 3) were formed generally according to the procedures of Working Example 1 with physical properties determined according to Working Example 2 using ASTM D 1037-06a. ASTM D 1037-06a was modified in that the test specimen was conditioned under 50% relative humidity and at 21.1° C. (70° F.). Density was determined by taking the particle board, weighing it, and dividing the weight by the volume of the particle board.

The dimensions for each particle board were 76.20 cm wide x 76.20 cm long with a thickness of 2.08 cm. However, board 3 is a multi-layer particle boardincluding three boards. The three boards included a core board having dimensions 76.20 cm wide x 76.20 cm long with a thickness of 2.08 cm with two face boards disposed along the major surfaces of the core board, each having the dimensions 76.20 cm wide x 76.20 cm long with a thickness of 0.416 cm.

The results in Table 3 show at least that including sodium trimetaphosphate can allow for higher loading of IsoClear 42% in the binder solution. As shown in Table 3 binders having sodium trimetaphosphate and an increased amount of IsoClear 42% resulted in an particle boardwith acceptable modulus of rupture and modulus of elasticity values along with improved internal bond strength values and thickness swell % values both after 2 hours and 24 hours

TABLE 3

| Particle Board | Binder | Binder Dose % | Water Content of the Binder and Wood Fiber | Density (kg/m³) | Modulus of Rupture (N/mm²) | Modulus of Elasticity (N/mm²) | Internal Bond Strength (N/mm²) | Thickness Swell % After 2 Hours | Thickness Swell % After 24 Hours |
|---|---|---|---|---|---|---|---|---|---|
| Comparative Particle Board | Comparative Binder | 13.0% | 10.4% | 690.4 | 11.5 | 2350 | 0.28 | 29% | 37% |
| Particle Board 1 | Binder 1 | 13.1% | 9.9% | 708.0 | 11.2 | 2370 | 0.31 | 36% | 46% |
| Particle Board 2 | Binder 2 | 13.1% | 9.9% | 693.6 | 11.9 | 2130 | 0.38 | 26% | 36% |
| Particle Board 3 | Face | 13.1% | 9.7% | 701.6 | 11.1 | 2240 | 0.31 | 29% | 37% |
| | Core | 13.1% | 10.7% | | | | | | |
| | Face | 13.1% | 9.7% | | | | | | |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

### Additional Examples

The following exemplary examples are provided, the numbering of which is not to be construed as designating levels of importance:

Example 1 provides an engineered wood precursor mixture comprising:
a plurality of wood substrates;
a binder reaction mixture present in a range of from 3 parts to 25 parts per 100 parts of the dry weight of the plurality of wood substrates, the binder composition comprising:
   an aqueous portion comprising:
      a carbohydrate-containing component in a range of from 2 wt% to 85 wt% based on a dry weight of the binder reaction mixture, the carbohydrate-containing component comprising glucose, fructose, or a mixture thereof, and the combined wt% of glucose, fructose, or mixture thereof in the carbohydrate-containing component is at least 60 wt%; and
      0.1 wt% to 10 wt% sodium trimetaphosphate based on a dry weight of the binder reaction mixture; and
   an at least partially non-dissolved polypeptide-containing component selected from soy flour, wheat gluten, or a combination thereof, in a range of from 20 wt% to 85 wt% based on the dry weight of the binder reaction mixture.

Example 2 provides the engineered wood precursor mixture of Example 1, wherein the carbohydrate-containing component is in a range of from 15 wt% to 65 wt% based on the dry weight of the binder reaction mixture.

Example 3 provides the engineered wood precursor mixture of any one of Examples 1 or 2, wherein the carbohydrate-containing component is in a range of from 40 wt% to 60 wt% based on the dry weight of the binder reaction mixture.

Example 4 provides the engineered wood precursor mixture of any one of Examples 1-3, wherein the carbohydrate-containing component comprises a glucose syrup, high fructose corn syrup, or a mixture thereof.

Example 5 provides the engineered wood precursor mixture of any one of Examples 1-4, wherein the carbohydrate-containing component comprises glucose, fructose or mixtures thereof and the total weight percent of glucose and fructose is in the range of 20 wt% to 60 wt% based on dry weight of the binder reaction mixture.

Example 6 provides the engineered wood precursor mixture of any one of Examples 1-5, wherein the polypeptide-containing component comprises soy flour, wherein the soy flour has from 40 wt% to 65 wt% protein based on the total soy flour present.

Example 7 provides the engineered wood precursor mixture of any one of Examples 1-6, wherein the polypeptide-containing component comprises soy flour and comprises from 20 wt% to 85 wt% of the dry weight of the binder reaction mixture.

Example 8 provides the engineered wood precursor mixture of Example 7, wherein the soy flour comprises from 30 wt% to 80 wt% of the dry weight the binder reaction mixture.

Example 9 provides the engineered wood precursor mixture of any one of Examples 1-8, wherein the aqueous component further comprises a base.

Example 10 provides the engineered wood precursor mixture of Example 9, wherein the base is present at 1 wt% to 33 wt% of a base based on a dry weight of the binder reaction mixture.

Example 11 provides the engineered wood precursor mixture of any one of Examples 9 or 10, wherein the base is in a range of from 3 wt% to 21 wt% based on the dry weight of the binder reaction mixture.

Example 12 provides the engineered wood precursor mixture of any one of Examples 9-11, wherein the base is in a range of from 4 wt% to 7 wt% based on the dry weight of the binder reaction mixture.

Example 13 provides the engineered wood precursor mixture of any one of Examples 9-12, wherein the base comprises NaOH, magnesium oxide, or mixtures thereof.

Example 14 provides the engineered wood precursor mixture of any one of Examples 9-13, wherein the base comprises NaOH.

Example 15 provides the engineered wood precursor mixture of any one of Examples 9-14, wherein a pH of the aqueous portion is greater than 10, for example 10.5, 11, 11.5, 12, 12.5, 13, 13.5, or 14

Example 16 provides the engineered wood precursor mixture of Example 15, wherein the pH of the aqueous portion is in a range of from 10 to 14.

Example 17 provides the engineered wood precursor mixture of any one of Examples 15 or 16, wherein the pH of the aqueous portion is in a range of from 11 to 14.

Example 18 provides the engineered wood precursor mixture of any one of Examples 1-17, wherein the carbohydrate-containing component comprises a glucose syrup having a dextrose equivalent (DE) of at least 60.

Example 19 provides the engineered wood precursor mixture of any one of Examples 1-18, wherein the carbohydrate-containing component comprises a glucose syrup having a dextrose equivalent (DE) of at least 80, for example, at least 85, at least 90, at least 95.

Example 20 provides the engineered wood precursor mixture of any one of Examples 1-19, wherein the carbohydrate-containing component comprises a high fructose corn syrup comprising at least 90 wt% fructose and glucose.

Example 21 provides the engineered wood precursor mixture of Example 20, wherein the high fructose corn syrup comprises at least 94 wt% fructose and glucose.

Example 22 provides the engineered wood precursor or mixture of any one of Examples 20 or 21, wherein the high fructose corn syrup comprises from 30 wt% to 70 wt% glucose.

Example 23 provides the engineered wood precursor mixture of any one of Examples 20-22, wherein the high fructose corn syrup comprises from 35 wt% to 65 wt% glucose.

Example 24 provides the engineered wood precursor mixture of any one of Examples 1-23, wherein the polypeptide-containing component further comprises a protein sourced from an animal protein, a casein salt, a plant protein, a soy flour, linseed flour, flaxseed flour, cottonseed flour, canola flour, sunflower flour, peanut flour, lupin flour, pea flour, and mixtures thereof.

Example 25 provides the engineered wood precursor mixture of any one of Examples 1-24, wherein the polypeptide-containing component comprises a soy flour.

Example 26 provides the engineered wood precursor mixture of Example 25, wherein the soy flour has a protein dispersibility index of at least 60.

Example 27 provides the engineered wood precursor mixture of any one of Examples 1-26 wherein the soy flour has a protein dispersibility index (PDI) in a range of from 70 to 95, for example a PDI from 80 to 90.

Example 28 provides the engineered wood precursor mixture of any one of Examples 1-27, wherein the polypeptide-containing component passes through a screen sized 100-mesh screen to a 635-mesh screen.

Example 29 provides the engineered wood precursor mixture of any one of Examples 1-28, wherein the polypeptide-containing component passes through a 100-mesh screen to a 400-mesh screen, for example a 150-mesh screen to 325-mesh screen.

Example 30 provides the engineered wood precursor mixture of any one of Examples 1-29, wherein the plurality of wood substrates comprise one or more strands, one or more particles, one or more fibers, or a mixture thereof.

Example 31 provides the engineered wood precursor mixture of any one of Examples 1-30, wherein the mixture comprises less than 5 wt% of urea-formaldehyde, or a mixture thereof.

Example 32 provides the engineered wood precursor mixture of any one of Examples 1-31, wherein the binder reaction mixture is substantially free of urea-formaldehyde, or a mixture thereof.

Example 33 provides the engineered wood precursor mixture of any one of Examples 1-32 further comprising sodium sulfite, sodium bisulfite, sodium metabisulfite, or a mixture thereof.

Example 34 provides the engineered wood precursor mixture of Example 33, wherein the sodium sulfite, sodium bisulfite, sodium metabisulfite, or a mixture thereof is present in a range of from 1 wt% to 10 wt%, based on the dry weight of the binder reaction mixture.

Example 35 provides the engineered wood precursor mixture of any one of Examples 33 or 34, wherein the binder reaction mixture present in a range of from 8 parts to 17 parts per 100 parts of the dry weight of the dry weight of the plurality of wood substrates.

Example 36 provides the engineered wood precursor mixture of any one of Examples 1-35, wherein a moisture content of the mixture applied to the plurality of wood substrates is in a range of from 7% to 25%.

Example 37 provides the engineered wood precursor mixture of any one of Examples 1-36, wherein a moisture content of the mixture applied to the plurality of wood substrates is in a range of from 9% to 13%.

Example 38 provides the engineered wood precursor of any one of Examples 1-37, wherein the sodium trimetaphosphate is in a range of from 0.4 wt% to 0.9 wt% based on the dry weight of the binder reaction mixture.

Example 39 provides the engineered wood precursor of any one of Examples 1-38, wherein the sodium trimetaphosphate is in a range of from 0.6 wt% to 0.8 wt% based on the dry weight of the binder reaction mixture.

Example 40 provides an engineered wood precursor mixture comprising:
a plurality of wood substrates;
a binder reaction mixture present in a range of from 3 parts to 25 parts per 100 parts of the dry weight of the plurality of wood substrates, the binder composition comprising:
   an aqueous portion comprising:
      a carbohydrate-containing component in a range of from 2 wt% to 85 wt% based on a dry weight of the binder reaction mixture, the carbohydrate-containing component comprising glucose, fructose, or a mixture thereof, and the combined wt% of glucose, fructose, or mixture thereof in the carbohydrate-containing component is at least 60 wt%;
      1 wt% to 33 wt% of a base based on a dry weight of the binder reaction mixture, wherein a pH of the aqueous portion is greater than 10, for example 10.5, 11, 11.5, 12, 12.5, 13, 13.5, or 14; and
      0.1 wt% to 10 wt% sodium trimetaphosphate based on a dry weight of the binder reaction mixture; and
an at least partially non-dissolved polypeptide-containing component selected from soy flour, wheat gluten, or a combination thereof, in a range of from 20 wt% to 85 wt% based on the dry weight of the binder reaction mixture.

Example 41 provides an engineered wood comprising a reaction product of the engineered wood precursor of any one of Examples 1-40.

Example 42 provides the engineered wood of Example 41, wherein the engineered wood comprises particle board, medium density fiber board, high density fiberboard, oriented strand board, engineered wood flooring, and combinations thereof.

Example 43 provides the engineered wood of any one of Examples 41 or 42, wherein the reaction product of the binder reaction mixture is in a range of from 3 parts to 25 parts per 100 parts of the dry weight of the plurality of wood substrates of the engineered wood.

Example 44 provides the engineered wood of any one of Examples 41-43, wherein the reaction product of the binder reaction mixture is in a range of from 8 parts to 17 parts per 100 parts of the dry weight of the plurality of wood substrates of the engineered wood.

Example 45 provides the engineered wood of any one of Examples 41-44, wherein a modulus of rupture of the engineered wood is in a range of from 0.5 N/mm² to 25 N/mm².

Example 46 provides the engineered wood of any one of Examples 41-45, wherein a modulus of rupture of the engineered wood is in a range of from 2 N/mm² to 22 N/mm².

Example 47 provides the engineered wood of any one of Examples 41-46, wherein a thickness swell% of the engineered wood measured after soaking the engineered wood in water for two hours to twenty-four hours is in a range of from 5% to 45%.

Example 48 provides the engineered wood of any one of Examples 41-47, wherein a thickness swell% of the engineered wood measured after soaking the engineered wood in water for two hours to twenty-four hours is in a range of from 20% to 40%.

Example 49 provides the engineered wood of any one of Examples 41-48, wherein a modulus of elasticity of the engineered wood is in a range of from 200 N/mm² to 3000 N/mm².

Example 50 provides the engineered wood of any one of Examples 41-49, wherein a modulus of elasticity of the engineered wood is in a range of from 2000 N/mm² to 2750 N/mm².

Example 51 provides the engineered wood of any one of Examples 41-50, wherein an internal bond strength is in a range of from 0.1 N/mm² to 0.5 N/mm².

Example 52 provides the engineered wood of any one of Examples 41-51, wherein an internal bond strength is in a range of from 0.2 N/mm² to 0.4 N/mm².

Example 53 provides the engineered wood of any one of Examples 41-52, wherein a modulus of rupture, the thickness swell%, modulus of elasticity, internal bond strength, or a combination thereof of the engineered wood is substantially similar to optionally a modulus of rupture, an internal bond strength, a thickness swell%, or a combination thereof of a corresponding engineered wood differing in that the reaction product comprises urea-formaldehyde, or a mixture thereof.

Example 54 provides the engineered wood of Example 53, wherein the modulus of rupture, the thickness swell%, modulus of elasticity, internal bond strength, or a combination thereof of the engineered wood is within 1% to 10% optionally of the modulus of elasticity, internal bond strength, modulus of rupture, the thickness swell%, or a combination thereof of the corresponding engineered wood.

Example 55 provides the engineered wood of any one of Examples 53 or 54, wherein the modulus of rupture, the thickness swell%, modulus of elasticity, internal bond strength, or a combination thereof of the engineered wood is within 1% to 5% optionally to the modulus of elasticity, internal bond strength, modulus of rupture, the thickness swell%, or a combination thereof of the corresponding engineered wood.

Example 56 provides the engineered wood of any one of Examples 53-55, wherein the modulus of rupture, the thickness swell%, modulus of elasticity, internal bond strength, or a combination thereof of the engineered wood is identical to optionally modulus of elasticity, internal bond strength, the modulus of rupture, the thickness swell%, or a combination thereof of the corresponding engineered wood.

Example 57 provides the engineered wood of any one of Examples 41-56, wherein the reaction product of the engineered wood precursor is homogenously distributed about the plurality of wood fibers.

Example 58 provides the engineered wood of any one of Examples 41-57, further comprising a swell-retardant agent distributed about the engineered wood.

Example 59 provides the engineered wood of Example 58, wherein swell-retardant agent is present in the engineered in a range of from 0.1 wt% to 1 wt% of the wood substrate.

Example 60 provides the engineered wood of any one of Examples 41-59, wherein the engineered wood is at least 1.2 meters wide and at least 2.8 meters long.

Example 61 provides the engineered wood of any one of Examples 41-60, wherein the engineered wood is at least 1.3 meters wide and at least 2.1 meters long.

Example 62 provides the engineered wood of any one of Examples 41-61, wherein the engineered wood comprises a plurality of layers formed from the engineered wood precursor mixture of any one of Examples 1-57.

Example 63 provides a method of making an engineered wood, the method comprising:
(a) mixing a carbohydrate-containing component and sodium trimetaphosphate, to produce a first mixture;
(b) mixing the first mixture produced at (a) with a plurality of wood substrates to obtain a second mixture;
(c) mixing the second mixture produced at (b) with a polypeptide-containing component to form a third mixture; and
(d) curing the third mixture formed at (c) to form the engineered wood.

Example 64 provides the method of Example 63, further comprising mixing the plurality of wood substrates with a swell-retardant component.

Example 65 provides the method of any one of Examples 63 or 64, wherein mixing at (b) is performed by spraying the carbohydrate-containing component and sodium trimetaphosphate to the plurality of wood substrates.

Example 66 provides the method of any one of Examples 63-65, wherein the polypeptide-containing component at (c) is in a powder form.

Example 67 provides the method of any one of Examples 63-66, further comprising mixing sodium sulfite, sodium bisulfite, sodium metabisulfite or a mixture thereof at (a), (b) (c), or a combination thereof.

Example 68 provides the method of any one of Examples 63-67, wherein mixing at (b) is performed for at least 1 minute.

Example 69 provides the method of any one of Examples 63-68, wherein mixing at (b) is performed for a time in a range of from 1 minute to 60 minutes.

Example 70 provides the method of any one of Examples 63-69, wherein mixing at (b) is performed for a time in a range of from 1 minute to 10 minutes.

Example 71 provides the method of any one of Examples 63-70, wherein mixing at (c) is performed for at least 1 minute.

Example 72 provides the method of any one of Examples 63-71, wherein mixing at (c) is performed for a time in a range of from 1 minute to 60 minutes.

Example 73 provides the method of any one of Examples 63-72, wherein mixing at (c) is performed for a time in a range of from 1 minute to 10 minutes.

Example 74 provides the method of any one of Examples 63-73, further comprising aging the first mixture obtained at (a) for at least 1, for example at least 26 hours before performing (b).

Example 75 provides the method of any one of Examples 63-74, further comprising aging the first mixture obtained at (a) for at least 50 hours before performing (b).

Example 76 provides the method of any one of Examples 63-75, further comprising aging the first mixture obtained at (a) for at least 120 hours before performing (b).

Example 77 provides the method of any one of Examples 63-76, further comprising aging the first mixture obtained at (a) for at time in a range of from 0.5 hours to 9 months, for example between 26 hours to 6 months, or 1 week to 3 months before performing (b).

Example 78 provides the method of any one of Examples 63-77, further comprising aging the first mixture obtained at (a) for at time in a range of from 50 hours 360 hours before performing (b).

Example 79 provides the method of any one of Examples 63-78, wherein curing at (d) comprises:

(e) hot pressing the third mixture formed at (c).

Example 80 provides the method of Example 79, wherein hot pressing at (e) is performed at a pressure of at most 500 psi.

Example 81 provides the method of any one of Examples 79-80, wherein hot pressing at (e) is performed at a pressure in a range of from 5 psi to 450 psi.

Example 82 provides the method of any one of Examples 79-81, wherein hot pressing at (e) is performed at a pressure in a range of from 30 psi to 400 psi.

Example 83 provides the method of any one of Examples 79-82, wherein a temperature of a platen of the press used for hot pressing at (e) is heated to a temperature in a range of at least 100° C.

Example 84 provides the method of any one of Examples 79-83, wherein a temperature of a platen of the press used for hot pressing at (e) is heated to a temperature in a range of at least 120° C.

Example 85 provides the method of any one of Examples 79-84, wherein a temperature of a platen of the press used for hot pressing at (e) is heated to a temperature in a range of from 100° C. to 220° C.

Example 86 provides the method of any one of Examples 79-85, wherein a temperature of a platen of the press used for hot pressing at (e) is heated to a temperature in a range of from 148° C. to 220° C.

Example 87 provides the method of any one of Examples 79-86, wherein a temperature of a platen of the press used for hot pressing at (e) is heated to a temperature in a range of from 120° C. to 160° C.

Example 88 provides the method of any one of Examples 63-87, further comprising (f) pressing at an ambient temperature.

Example 89 provides the method of any one of Examples 63-88, wherein the third mixture is present in a range of from 3 parts to 25 parts per 100 parts of the dry weight of the plurality of wood substrates.

Example 90 provides the method of any one of Examples 63-89, wherein the first mixture produced at (a) is aqueous and the carbohydrate containing component is in a range of from 2 wt% to 85 wt% based on a dry weight of the polypeptide-containing component, carbohydrate-component, and the sodium trimetaphosphate, the carbohydrate-containing component comprising glucose, fructose, or a mixture thereof, and the combined wt% of glucose, fructose, or mixture thereof in the carbohydrate-containing component is at least 60 wt%.

Example 91 provides the method of any one of Examples 63-90, wherein the first mixture produced at (a) is aqueous and the carbohydrate containing component is in a range of from 40 wt% to 60 wt% based on a dry weight of the polypeptide-containing component, carbohydrate-component, and the sodium trimetaphosphate, the carbohydrate-containing component comprising glucose, fructose, or a mixture thereof, and the combined wt% of glucose, fructose, or mixture thereof in the carbohydrate-containing component is at least 60 wt%.

Example 92 provides the method of any one of Examples 63-91, wherein the first mixture produced at (a) is aqueous and the sodium trimetaphosphate is in a range of from 0.1 wt% to 10 wt% based on a dry weight of the polypeptide-containing component, carbohydrate-component, and the sodium trimetaphosphate.

Example 93 provides the method of any one of Examples 63-92, wherein the first mixture produced at (a) is aqueous and the sodium trimetaphosphate is in a range of from 0.6 wt% to 0.8 wt% based on a dry weight of the polypeptide-containing component, carbohydrate-component, and the sodium trimetaphosphate.

Example 94 provides the method of any one of Examples 63-93, wherein the first mixture produced at (a) is aqueous and the sodium trimetaphosphate is in a range of from 0.1 wt% to 1 wt% based on a dry weight of the polypeptide-containing component, carbohydrate-component, and the sodium trimetaphosphate.

Example 95 provides the method of any one of Examples 63-94, wherein the first mixture produced at (a) is aqueous and further comprises a base.

Example 96 provides the method of Example 95, wherein the first mixture produced at (a) is aqueous and comprises 1 wt% to 33 wt% of the base based on the dry weight of polypeptide-containing component, carbohydrate-component, and the sodium trimetaphosphate.

Example 97 provides the method of any one of Examples 63-96, wherein the base comprises NaOH, magnesium oxide, or mixtures thereof.

Example 98 provides the method of any one of Examples 63-97, wherein the base comprises NaOH.

Example 99 provides the method of any one of Examples 95-98, wherein, a pH of the second mixture formed at (b) is greater than 10, for example 10.5, 11, 11.5, 12, 12.5, 13, 13.5, or 14.

Example 100 provides the method of Example 99, wherein the pH of the second mixture formed at (b) is in a range of from 10 to 14.

Example 101 provides the method of any one of Examples 99 or 100, wherein the pH of the second mixture formed at (b) is in a range of from 11 to 14.

Example 102 provides the method of any one of Example 63-101, wherein the polypeptide component is selected from soy flour, wheat gluten, or a combination thereof and is in a range of from 20 wt% to 85 wt% based on the dry weight of polypeptide-containing component, carbohydrate-component, and the sodium trimetaphosphate.

Example 103 provides the method of any one of Examples 63-102, wherein the carbohydrate-containing component comprises a glucose syrup, high fructose corn syrup, or a mixture thereof.

Example 104 provides the method of any one of Examples 63-103, wherein the carbohydrate-containing component comprises glucose, fructose or mixtures thereof and the total weight percent of glucose and fructose is in the range of 20 wt% to 60 wt% based on the dry weight of polypeptide-containing component, carbohydrate-component, and the sodium trimetaphosphate.

Example 105 provides the method of any one of Examples 63-104, wherein the carbohydrate-containing component comprises glucose, fructose or mixtures thereof.

Example 106 provides the method of any one of Examples 63-105, wherein the polypeptide-containing component comprises soy flour, wherein the soy flour has from 40 wt% to 65 wt% protein based on the total soy flour present.

Example 107 provides the method of any one of Examples 63-106, wherein the polypeptide-containing component comprises soy flour and comprises from 20 wt% to 85 wt% of the dry weight of polypeptide-containing component, carbohydrate-component, and the sodium trimetaphosphate.

Example 108 provides the method of any one of Examples 63-107, wherein the soy flour comprises from 30 wt% to 80 wt% of the dry weight of polypeptide-containing component, carbohydrate-component, and the sodium trimetaphosphate.

Example 109 provides the method of any one of Examples 63-108, wherein the carbohydrate-containing component comprises a glucose syrup having a dextrose equivalent (DE) of at least 60.

Example 110 provides the method of any one of Examples 63-109, wherein the carbohydrate-containing component comprises a glucose syrup having a dextrose equivalent (DE) of at least 80, for example, at least 85, at least 90, at least 95.

Example 111 provides the method of any one of Examples 63-110, wherein the carbohydrate-containing component comprises a high fructose corn syrup comprising at least 90 wt% fructose and glucose.

Example 112 provides the method of Example 111, wherein the high fructose corn syrup comprises at least 94 wt% fructose and glucose.

Example 113 provides the method of any one of Examples 111 or 112, wherein the high fructose corn syrup comprises from 30 wt% to 70 wt% glucose.

Example 114 provides the method of any one of Examples 111-113, wherein the high fructose corn syrup comprises from 35 wt% to 65 wt% glucose.

Example 115 provides the method of any one of Examples 63-114, wherein the polypeptide-containing component further comprises a protein sourced from an animal protein, a casein salt, a plant protein, a soy flour, linseed flour, flaxseed flour, cottonseed flour, canola flour, sunflower flour, peanut flour, lupin flour, pea flour, and mixtures thereof.

Example 116 provides the method of any one of Examples 63-115, wherein the polypeptide-containing component comprises a soy flour.

Example 117 provides the method of Example 116, wherein the soy flour has a protein dispersibility index of at least 60.

Example 118 provides the method of any one of Examples 63-117, wherein the soy flour has a protein dispersibility index (PDI) in a range of from 70 to 95, for example a PDI from 80 to 90.

Example 119 provides the method of any one of Examples 63-118, wherein the polypeptide-containing component passes through a screen sized 100-mesh screen to a 635-mesh screen.

Example 120 provides the method of any one of Examples 63-119, wherein the polypeptide-containing component passes through a screen sized 100-mesh screen to a 400-mesh screen, for example a screen size of from 150 to 325.

Example 121 provides the method of any one of Examples 63-120, wherein the plurality of wood substrates comprise one or more strands, one or more particles, one or more fibers, or a mixture thereof.

Example 122 provides the method of any one of Examples 63-121, wherein the mixture(s) produced at (a), (b), (c), or a combination thereof comprises less than 5 wt% of urea-formaldehyde, or a mixture thereof.

Example 123 provides the method of any one of Examples 63-122, wherein the mixture(s) produced at (a), (b), (c), or a combination thereof is substantially free of urea-formaldehyde, or a mixture thereof.

Example 124 provides the method of any one of Examples 63-123, wherein the mixture(s) produced at (a), (b), (c), or a combination thereof further comprises sodium sulfite, sodium bisulfite, or a mixture thereof.

Example 125 provides the method of any one of Examples 63-124, wherein the engineered wood comprises particle board, medium density fiber board, high density fiberboard, oriented strand board, engineered wood flooring, and combinations thereof.

Example 126 provides the method of any one of Examples 63-125, wherein a modulus of rupture of the engineered wood is in a range of from 0.5 N/mm² to 25 N/mm².

Example 127 provides the method of any one of Examples 63-126, wherein a modulus of rupture of the engineered wood is in a range of from 2 N/mm² to 22 N/mm².

Example 128 provides the method of any one of Examples 63-127, wherein a thickness swell% of the engineered wood measured after soaking the engineered wood in water for two hours to twenty-four hours is in a range of from 5% to 45%.

Example 129 provides the method of any one of Examples 63-128, wherein a thickness swell% of the engineered wood measured after soaking the engineered wood in water for two hours to twenty-four hours is in a range of from 20% to 40%.

Example 130 provides the method of any one of Examples 63-129, wherein a modulus of elasticity of the engineered wood is in a range of from 200 N/mm² to 3000 N/mm².

Example 131 provides the method of any one of Examples 63-130, wherein a modulus of elasticity of the engineered wood is in a range of from 500 N/mm² to 2750 N/mm².

Example 132 provides the method of any one of Examples 63-131, wherein an internal bond strength of the engineered wood is in a range of from 0.1 N/mm² to 0.5 N/mm².

Example 133 provides the method of any one of Examples 63-132, wherein an internal bond strength of the engineered wood is in a range of from 0.2 N/mm² to 0.4 N/mm².

Example 134 provides the method of any one of Examples 127-133, wherein the modulus of rupture, the thickness swell%, modulus of elasticity, internal bond strength, or a combination thereof of the engineered wood is substantially similar to optionally a modulus of rupture, a thickness swell%, internal bond strength, or a combination thereof of a corresponding engineered wood differing in that the reaction product comprises urea-formaldehyde, or a mixture thereof.

Example 135 provides the method of Example 134, wherein the modulus of rupture, the thickness swell%, modulus of elasticity, internal bond strength, or a combination thereof of the engineered wood is within 1% to 10% optionally of the modulus of rupture, the thickness swell%, internal bond strength, or a combination thereof of the corresponding engineered wood.

Example 136 provides the method of any one of Examples 134 or 135, wherein the modulus of rupture, the thickness swell%, modulus of elasticity, internal bond strength, or a combination thereof of the engineered wood is within 1% to 5% optionally to the modulus of rupture, the thickness swell%, internal bond strength, or a combination thereof of the corresponding engineered wood.

Example 137 provides the method of any one of Examples 127-136, wherein the modulus of rupture, the thickness swell%, modulus of elasticity, internal bond strength, or a combination thereof of the engineered wood is identical to optionally the modulus of rupture, the thickness swell%, internal bond strength, or a combination thereof of the corresponding engineered wood.

Example 138 provides the method of any one of Examples 63-137, further comprising repeating the steps of any one of clams 55-131 to form a second engineered wood and combining the second engineered wood with the engineered wood formed in any one of Examples 55-131 to form a multi-layered engineered wood.

Example 139 provides a method of making an engineered wood, the method comprising:
(a) mixing a carbohydrate-containing component, a base, and sodium trimetaphosphate, to produce a first mixture;
(b) mixing the first mixture produced at (a) with a plurality of wood substrates to obtain a second mixture;
(c) mixing the second mixture produced at (b) with a polypeptide-containing component to form a third mixture; and
(d) curing the third mixture formed at (c) to form the engineered wood, wherein wherein the first mixture produced at (a) is aqueous and the sodium trimetaphosphate is in a range of from 0.1 wt% to 1 wt%, the carbohydrate component is present in a range of 20 wt% to 85 wt%, the base is present in a range of from 1 wt% to 33 wt%, and the polypeptide component is present in a range of from 20 wt% to 85 wt%, each based on a dry weight of the polypeptide-containing component, carbohydrate-component, and the sodium trimetaphosphate.

What is claimed is:

1. An engineered wood precursor mixture comprising:
a plurality of wood substrates;
a binder reaction mixture present in a range of from 3 parts to 25 parts per 100 parts of the dry weight of the plurality of wood substrates, the binder composition comprising:
an aqueous portion comprising:
a carbohydrate-containing component in a range of from 2 wt% to 85 wt% based on a dry weight of the binder reaction mixture, the carbohydrate-containing component comprising glucose, fructose, or a mixture thereof, and the combined wt% of glucose, fructose, or mixture thereof in the carbohydrate-containing component is at least 60 wt%;
a base is present at 1 wt% to 33 wt% of a base based on a dry weight of the binder reaction mixture; and
0.1 wt% to 10 wt% sodium trimetaphosphate based on a dry weight of the binder reaction mixture; and
an at least partially non-dissolved polypeptide-containing component comprising soy flour, in a range of from 20 wt% to 85 wt% based on the dry weight of the binder reaction mixture.

2. The engineered wood precursor mixture of claim 1, wherein the carbohydrate-containing component is in a range of from 15 wt% to 65 wt% based on the dry weight of the binder reaction mixture.

3. (canceled)

4. (canceled)

5. The engineered wood precursor mixture of claim 2, wherein the total weight percent of glucose and fructose is in the range of 20 wt% to 60 wt% based on dry weight of the binder reaction mixture.

6. (canceled)

7. The engineered wood precursor mixture of claim 1, wherein the soy flour comprises from 30 wt% to 80 wt% of the dry weight of the binder reaction mixture.

8-10. (canceled)

11. The engineered wood precursor mixture of claim 1, wherein the base is in a range of from 3 wt% to 21 wt% based on the dry weight of the binder reaction mixture.

12. (canceled)

13. The engineered wood precursor mixture of claim 1, wherein the base comprises NaOH.

14. (canceled)

15. (canceled)

16. The engineered wood precursor mixture of claim 1, wherein the pH of the aqueous portion is in a range of from 11 to 14.

17. (canceled)

18. The engineered wood precursor mixture of claim 1, wherein the carbohydrate-containing component comprises a glucose syrup having a dextrose equivalent (DE) of at least 80.

19. (canceled)

20. The engineered wood precursor mixture of claim 1, wherein the carbohydrate-containing component comprises a high fructose corn syrup comprising at least 90 wt% fructose and glucose.

21. The engineered wood precursor mixture of claim 20, wherein the high fructose corn syrup comprises at least 94 wt% fructose and glucose.

22. The engineered wood precursor mixture of claim 21, wherein the high fructose corn syrup comprises from 30 wt% to 70 wt% glucose.

23-26. (canceled)

27. The engineered wood precursor mixture of claim 1, wherein the soy flour has a protein dispersibility index (PDI) in a range of from 70 to 95.

28. (canceled)

29. (canceled)

30. The engineered wood precursor mixture of claim 1, wherein the plurality of wood substrates comprise one or more strands, one or more particles, one or more fibers, or a mixture thereof.

31. (canceled)

32. (canceled)

33. The engineered wood precursor mixture of claim 1, further comprising sodium sulfite, sodium bisulfite, sodium metabisulfite, or a mixture thereof.

34. (canceled)

35. The engineered wood precursor mixture of claim 1, wherein the binder reaction mixture present in a range of from 8 parts to 17 parts per 100 parts of the dry weight of the plurality of wood substrates.

36. (canceled)

37. The engineered wood precursor mixture of claim 1, wherein a moisture content of the engineered wood precursor mixture is in a range of from 9% to 13%.

38. The engineered wood precursor of claim 1, wherein the sodium trimetaphosphate is in a range of from 0.4 wt% to 0.9 wt% based on the dry weight of the binder reaction mixture.

39. (canceled)

40. (canceled)

41. An engineered wood comprising a reaction product of the engineered wood precursor of claim 1.

42. The engineered wood of claim 41, wherein the engineered wood comprises particle board, medium density fiber board, high density fiberboard, oriented strand board, engineered wood flooring, and combinations thereof.

43-57. (canceled)

58. The engineered wood precursor mixture of claim 1, further comprising a swell-retardant agent.

59-139. (canceled)
